(19) United States
(12) Patent Application Publication
(10) Pub. No.: US 2013/0180464 A1
(43) Pub. Date: Jul. 18, 2013

(54) Pet comb device

(71) Applicant: Hua Tu, Changhua (TW)

(72) Inventor: Hua Tu, Changhua (TW)

(21) Appl. No.: 13/374,842

(22) Filed: Jan. 17, 2012

(51) Int. Cl. A01K 13/00

(52) U.S. Cl. 119/625

(57) ABSTRACT

A pet comb device includes a comb assembly having two comb members mounted together and each comb member having a number of teeth formed in the bottom portion for forming a number of slots between the teeth, and the teeth of the comb members are offset from each other and arranged in a stagger-way for suitably and effectively engaging with a hair of a pet. The comb members each include an outer covering applied onto an outer peripheral portion of an inner core element, and the teeth of the comb members each also include an outer covering applied onto an outer peripheral portion of an inner core element of the teeth for increasing a friction between the teeth and the hair of the pet.

### BACKGROUND OF THE INVENTION

1. Field of the Invention

The present invention relates to a pet comb device, and more particularly to a pet comb device including an improved structure and designed for suitably and effectively engaging with the hair of the pet and for quickly and effectively removing fleas, ticks, other insects, loose hair, and debris from the pet.

2. Description of the Prior Art

Many families have raised pets which normally include a hairy body having a large number of fleas, ticks, other insects, hair and other debris that are required to be clean or loosened or removed from the pet, such that a variety of pet comb devices have been developed for loosening or removing fleas, ticks, other insects, loose hair, and debris from the pet.

Typical comb devices comprise a number of tines or teeth extended from a comb base or comb body for engaging with the pet and for loosening the fleas, ticks, other insects, loose hair and other debris, and for removing fleas, ticks, other insects, loose hair, and debris from the pet.

For example, U.S. Design Patent No. D422,760 to Ticehurst, and U.S. Design Patent No. D610,755 to Lin disclose two of the typical comb devices each comprising a number of tines or teeth extended from a comb base or comb body for engaging with and for loosening and for removing fleas, ticks, other insects, loose hair, and debris from the pet.

However, the tines or teeth that are extended from the comb base or comb body normally include a smooth outer appearance or outer peripheral portion that may not be used to effectively and quickly remove fleas, ticks, other insects, loose hair, and debris from the pet.

The present invention has arisen to mitigate and/or obviate the afore-described disadvantages of the conventional pet comb devices.

### SUMMARY OF THE INVENTION

The primary objective of the present invention is to provide a pet comb device including an improved structure and designed for suitably and effectively engaging with the hair of the pet and for quickly and effectively removing fleas, ticks, other insects, loose hair, and debris from the pet.

In accordance with one aspect of the invention, there is provided a pet comb device comprising a comb assembly including a first comb member and a second comb member mounted together and each having a bottom portion and each having a number of teeth formed and provided on the bottom portion thereof for forming a number of slots between the teeth respectively, and the teeth of the first comb member and the teeth of the second comb member are offset from each other and arranged in a stagger-way for suitably and effectively engaging with a hair of a pet and for quickly and effectively removing fleas, ticks, other insects, loose hair, and debris from the pet.

The first and the second comb members of the comb assembly each include an inner core element and an outer covering applied onto an outer peripheral portion of the core element, and the teeth of the first and the second comb members each include an inner core element and an outer covering applied onto an outer peripheral portion of the inner core element of the teeth.

The inner core element of the first and the second comb members is made of a harder material, such as a synthetic or plastic material for providing a suitable stiffness for the comb members. The outer covering of the first and the second comb members is made of a soft material, such as a silicon or rubber material for providing a suitable friction between the teeth and the hair of the pet.

A handle may further be provided, and the first and the second comb members of the comb assembly are attached or mounted or secured to the handle. The handle includes a compartment formed therein for receiving and engaging with the first and the second comb members and for securing to the first and the second comb members to the handle. The first and the second comb members of the comb assembly each include a curved surface formed in one side portion of the teeth for suitably and smoothly engaging with the hair of the pet.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a pet comb device in accordance with the present invention, in which a portion of the comb base or comb assembly has been cut off for showing the inner structure of the comb base or comb assembly;

FIG. 2 is a front plan schematic view of the comb base or comb assembly;

FIG. 3 is a cross sectional view of the comb base or comb assembly for the pet comb device, taken along lines 3-3 of FIG. 2;

FIG. 4 is a bottom plan schematic view of the comb base or comb assembly; and

FIG. 5 is a partial exploded of the comb base or comb assembly for the pet comb device.

### DETAILED DESCRIPTION OF THE PREFERRED EMBODIMENT

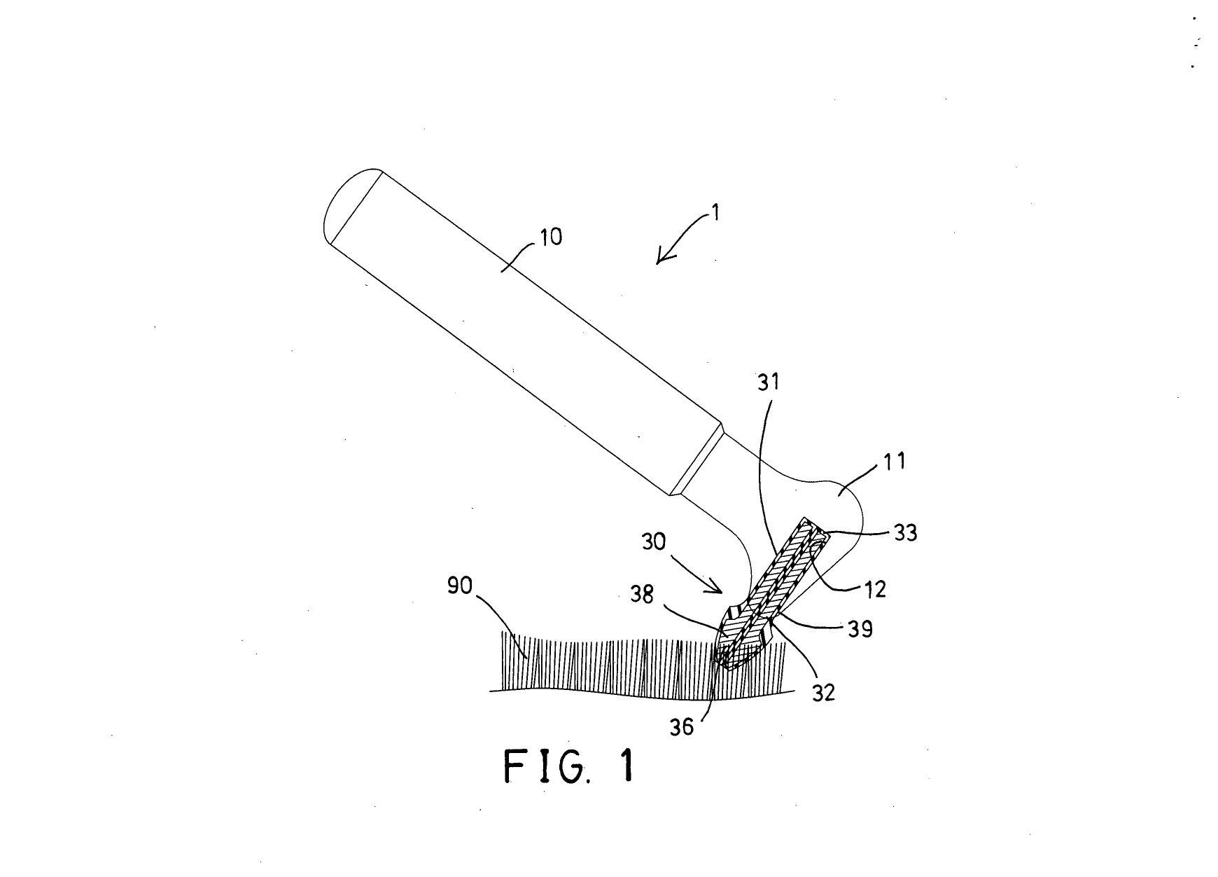

Referring to the drawings, and initially to FIG. 1, a pet comb device 1 in accordance with the present invention comprises a hand grip or handle 10, and a comb base or comb assembly 30 attached or mounted or secured to one end portion 11 of the handle 10 for engaging with the hair 90 of the pet and for loosening the fleas, ticks, other insects, loose hair and other debris, and for removing fleas, ticks, other insects, loose hair, and debris from the pet. For example, the handle 10 includes a space or compartment 12 formed therein, such as formed in the one end portion 11 thereof for receiving or engaging with the comb base or comb assembly 30 and for attaching or mounting or securing or coupling the comb base or comb assembly 30 to the handle 10 with latches or fasteners (not shown), adhesive materials, force-fitted engagements, welding processes, or the like.

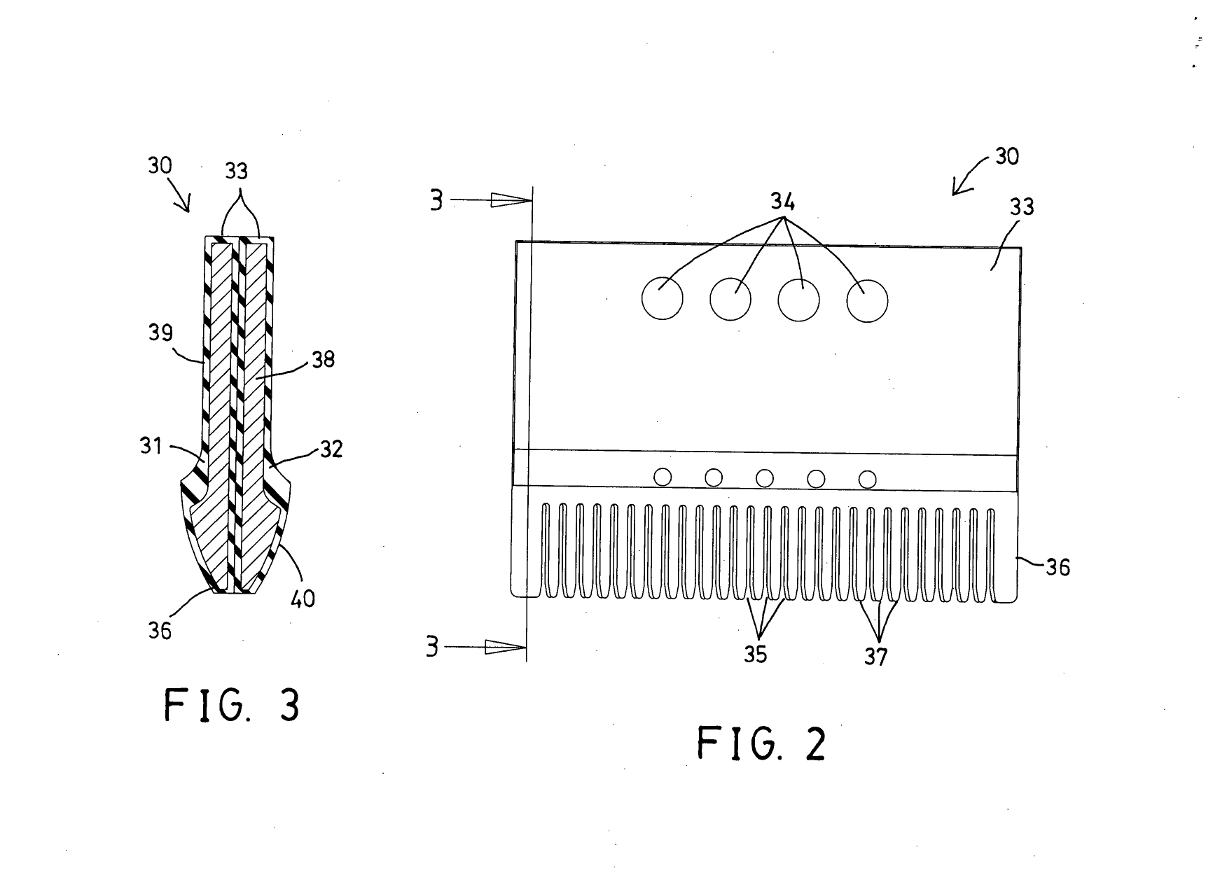

Referring next to FIGS. 2-5, the comb assembly 30 includes one or more (such as two) comb members 31, 32, or first and second comb members 31, 32 having a substantially anti or mirror symmetric structure, as best shown in FIGS. 1, 3, 5, and attached or mounted together, and each having one or more holes 34 formed therein, such as formed in the one side or upper portion 33 thereof for engaging with or into the compartment 12 of the handle 10 and for solidly and stably attached or mounted or secured to the handle 10 with latches or fasteners (not shown) or the like, and the comb members 31, 32 each include a number of slits or slots 35 formed in the other side or bottom portion 36 thereof for forming or defining a number of tines or teeth 37 between the slots 35 thereof; or each relatively include a number of tines or teeth 37 extended or formed or provided on the other side or bottom portion 36 thereof for forming or defining a number of slits or slots 35 between the tines or teeth 37.

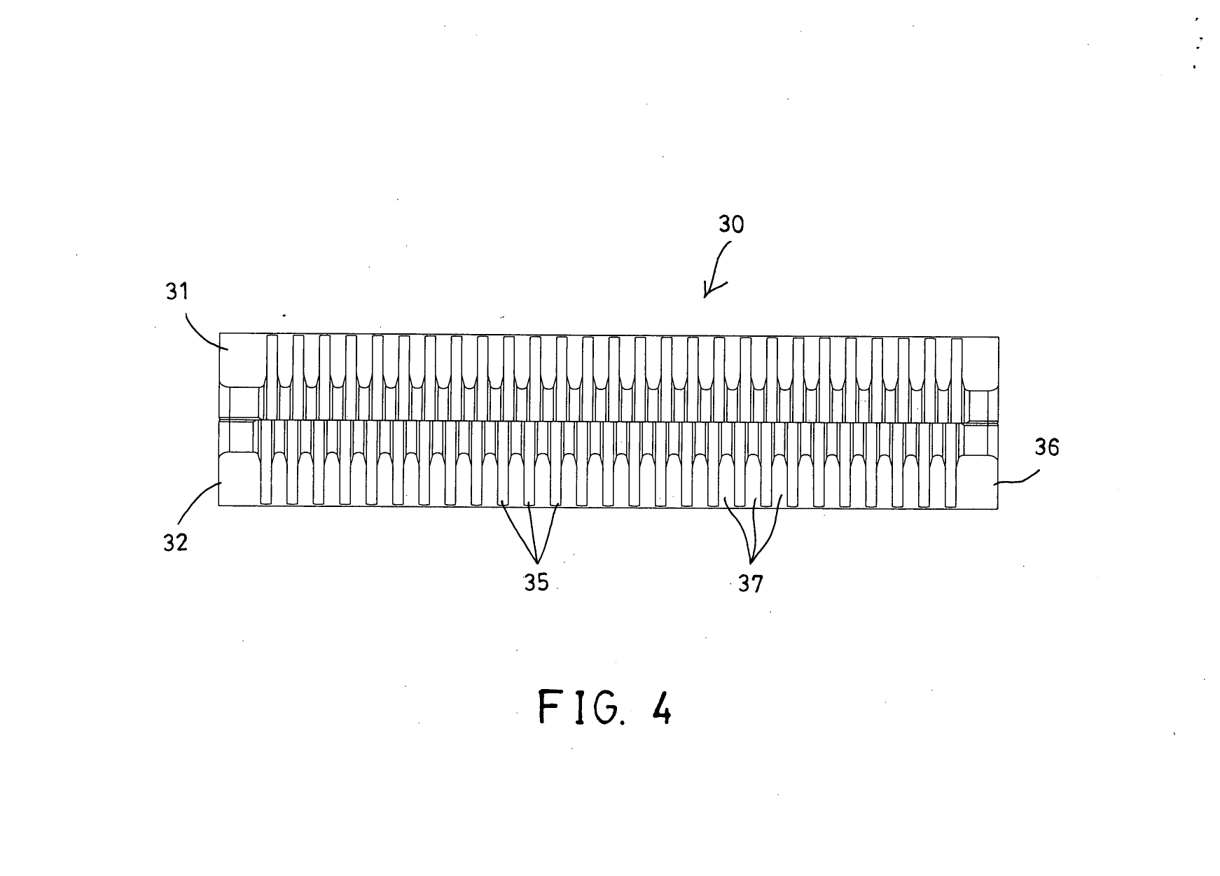

As shown in FIGS. 2 and 4, the tines or teeth 37 of the comb members 31, 32 are not aligned with each other, and are partially offset from each other, and are arranged in a stagger-way or crisscross structure, and are partially extended into the slots 35 of the other comb member 32, 31, but the slots 35 of the comb members 31, 32 have not been completely shielded or blocked by the tines or teeth 37 of the other comb member 32, 31, for allowing the hair 90 of the pet to be suitably engaged with or moved through the slots 35 of the comb members 31, 32, and to be suitably and effectively engaged with the tines or teeth 37 of the comb members 31, 32, and thus for allowing the fleas, ticks, other insects, loose hair, and debris to be suitably and effectively clean or loosened or removed or disengaged from the pet.

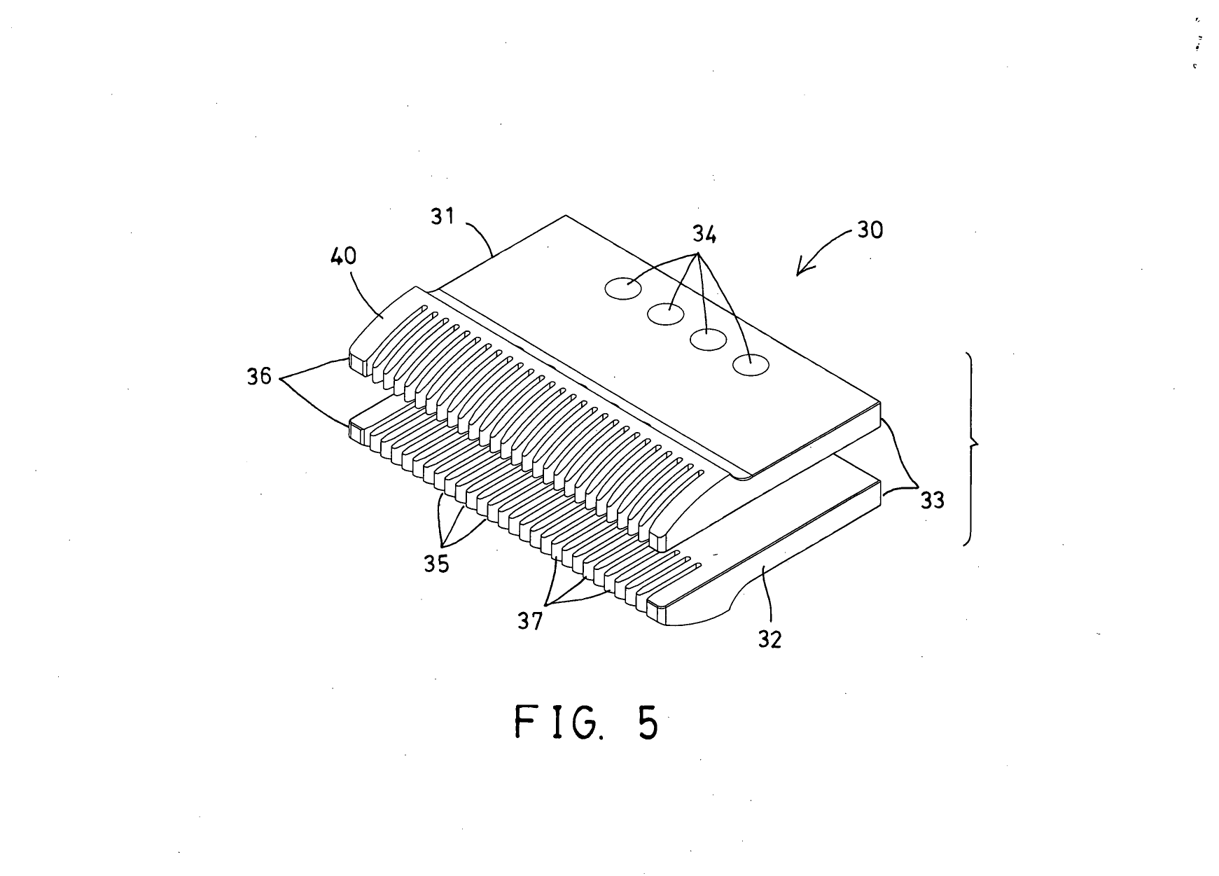

As shown in FIGS. 1 and 3, the comb members 31, 32 of the comb assembly 30 each include an inner body or core element 38 made of harder materials, such as plastic materials, and an outer covering 39 made of soft materials, such as rubber or silicon materials attached or mounted or applied onto the outer peripheral portion of the core element 38 for softly and comfortably engaging with the pet and for increasing a friction between the teeth 37 and the hair 90 of the pet and for effectively loosening and removing fleas, ticks, other insects, loose hair, and debris from the pet. It is to be noted that the teeth 37 each also include an inner body or core element 38 made of harder materials and an outer covering 39 made of soft materials attached or mounted or applied onto the outer peripheral portion of the core element 38 for increasing a friction between the teeth 37 and the hair 90 of the pet. As shown in FIGS. 3 and 5, the comb members 31, 32 of the comb assembly 30 each include a curved surface 40 formed in one side portion of each of the teeth 37 for smoothly engaging with the pet.

Accordingly, the pet comb device in accordance with the present invention includes an improved structure and designed for suitably and effectively engaging with the hair of the pet and for quickly and effectively removing fleas, ticks, other insects, loose hair, and debris from the pet.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pet comb device comprising:
a comb assembly including a first comb member and a second comb member mounted together and each having a bottom portion and each having a plurality of teeth formed and provided on said bottom portion thereof for forming a plurality of slots between said teeth respectively, and said teeth of said first comb member and said teeth of said second comb member being offset from each other and arranged in a stagger-way for engaging with a hair of a pet.

2. The pet comb device as claimed in claim 1, wherein said first and said second comb members of said comb assembly each include an inner core element and an outer covering applied onto an outer peripheral portion of said core element, and said teeth of said first and said second comb members each include an inner core element and an outer covering applied onto an outer peripheral portion of said inner core element of said teeth.

3. The pet comb device as claimed in claim 2, wherein said inner core element of said first and said second comb members is made of a harder material.

4. The pet comb device as claimed in claim 2, wherein said inner core element of said first and said second comb members is made of a plastic material.

5. The pet comb device as claimed in claim 2, wherein said outer covering of said first and said second comb members is made of a soft material.

6. The pet comb device as claimed in claim 2, wherein said outer covering of said first and said second comb members is made of a rubber material.

7. The pet comb device as claimed in claim 1 further comprising a handle, and said first and said second comb members of said comb assembly are attached to said handle.

8. The pet comb device as claimed in claim 7, wherein said handle includes a compartment formed therein for receiving and engaging with said first and said second comb members and for securing to said first and said second comb members to said handle.

9. The pet comb device as claimed in claim 1, wherein said first and said second comb members of said comb assembly each include a curved surface formed in one side portion of said teeth.
